(19) United States
(12) Patent Application Publication
(10) Pub. No.: US 2015/0129691 A1
(43) Pub. Date: May 14, 2015

(54) LOTTERY TICKET DESTRUCTION APPARATUS

(71) Applicant: SAINT-FUN INTERNATIONAL LTD., New Taipei City (TW)

(72) Inventors: Jenq-Huey Shyu, New Taipei City (TW); Wei-Liang Liao, New Taipei City (TW)

(73) Assignee: SAINT-FUN INTERNATIONAL LTD., New Taipei City (TW)

(21) Appl. No.: 14/080,784

(22) Filed: Nov. 14, 2013

(51) Int. Cl. B02C 18/22; B02C 25/00

(52) U.S. Cl. CPC B02C 18/2283; B02C 25/00
USPC 241/34

(57) ABSTRACT

A lottery ticket destruction apparatus includes a housing of flip-turn design convenient to open for maintenance, a motor mounted in the housing, a transmission gear set mounted on the outside of the housing and coupled to the motor, a set of sheet-transfer rollers rotatable by the transmission gear set at a low speed to flatten inserted lottery tickets, a set of rotary cutters disposed below the set of sheet-transfer rollers and rotatable by the transmission gear set at a middle speed to cut an inserted series of lottery tickets into three narrow elongated pieces, and a set of pull-and-push rollers disposed below the set of rotary cutters and rotatable by the transmission gear set at a high speed to stretch the cut pieces of the series of lottery tickets into fragments.

### BACKGROUND OF THE INVENTION

(a) Field of the Invention

The present invention relates to an apparatus for destructing lottery tickets, and more particularly, to a lottery ticket destruction apparatus, which is capable of cutting and stretching every piece of lottery ticket into fragments, saving waste lottery ticket storage space and facilitating a follow-up procedure.

(b) Description of the Prior Art

Many lottery ticket destruction apparatuses are known. For example, Taiwan Utility Numbers 84208584, 85204451, and 85203923 disclose lottery ticket cutting and destruction techniques. These designs teach the operation of rotary cutters to cut a series of lottery tickets into three narrow elongated strips. These prior art designs cannot cut every single lottery ticket into small pieces. The cut three narrow elongated strips will curl up and get tangled together, occupying much waste storage space in the waste basket. Thus, the user needs to frequently clean the waste basket, not only complicating the lottery destruction work but also significantly lowering the lottery destruction efficiency.

Further, according to the prior art lottery ticket destruction apparatus designs, the major components, such as guide plates, sensors, rotary cutters and motor are mounted in enclosed compartments in the housing. This arrangement complicates the maintenance and repair works. When a lottery ticket is jammed in the apparatus, a complicated dismounting procedure is necessary, making the maintenance inconvenient and difficult.

### SUMMARY OF THE INVENTION

The present invention has been accomplished under the circumstances in view. It is therefore the main object of the present invention to provide an improved lottery ticket destruction apparatus, which comprises a housing, a transmission gear set, a set of sheet-transfer rollers rotatable at a low speed, a set of rotary cutters rotatable at a middle speed, and a set of pull-and-push rollers rotatable at a high speed. The housing has mounted therein a motor for driving the transmission gear set to rotate the set of sheet-transfer rollers rotatable at a low speed in flattening an inserted series of lottery tickets, the set of rotary cutters rotatable at a middle speed into cutting the flattened series of lottery tickets into three narrow elongated strips, and the set of pull-and-push rollers rotatable at a high speed in stretching the three narrow elongated strips of the series of lottery tickets into fragments by separating the cut pieces of one lottery ticket from those of other lottery tickets. Thus, the destructed lottery ticket fragments do not occupy much storage space, facilitating further treatment and enhancing lottery ticket destruction efficiency.

Preferably, the housing is a flip-turn design, comprising a top cover shell and a bottom body shell. The top cover shell and the bottom body shell are pivotally coupled together so that the top cover shell can be conveniently opened from the bottom body shell. Further, the gears of the transmission gear set, the sheet-transfer rollers of the set of sheet-transfer rollers, the rotary cutters of the set of rotary cutters and the pull-and-push rollers of the set of pull-and-push rollers are respectively arranged in pair and mounted in the top cover shell and bottom body shell of the housing in a matched manner. When the top cover shell is closed on the bottom body shell, a lottery ticket destruction operation can then be started. When the top cover shell is opened, the user can visually check the component parts in the housing, facilitating maintenance or replacement of internal component parts. In case of lottery ticket jam, the top cover shell can be easily opened for troubleshooting without performing any complicated dismounting procedure.

### BRIEF DESCRIPTION OF THE DRAWINGS

FIG. 1 is a top perspective view of a lottery ticket destruction apparatus in accordance with the present invention.

FIG. 2 corresponds to FIG. 1, illustrating the top cover shell of the housing opened from the bottom body shell.

FIG. 3 is a top perspective view of a part of the lottery ticket destruction apparatus in accordance with the present invention.

FIG. 4 is a schematic side elevation view of the lottery ticket destruction apparatus in accordance with the present invention.

FIG. 5 is a schematic drawing of the present invention, illustrating the transmission gear set rotated by the pinion.

FIG. 6 is a schematic drawing illustrating lottery tickets transferred through the set of sheet-transfer rollers during the operation of the lottery ticket destruction apparatus in accordance with the present invention.

FIG. 7 is a schematic drawing illustrating lottery tickets transferred through the set of rotary cutters and the set of pull-and-push rollers during the operation of the lottery ticket destruction apparatus in accordance with the present invention.

### DETAILED DESCRIPTION OF THE PREFERRED EMBODIMENTS

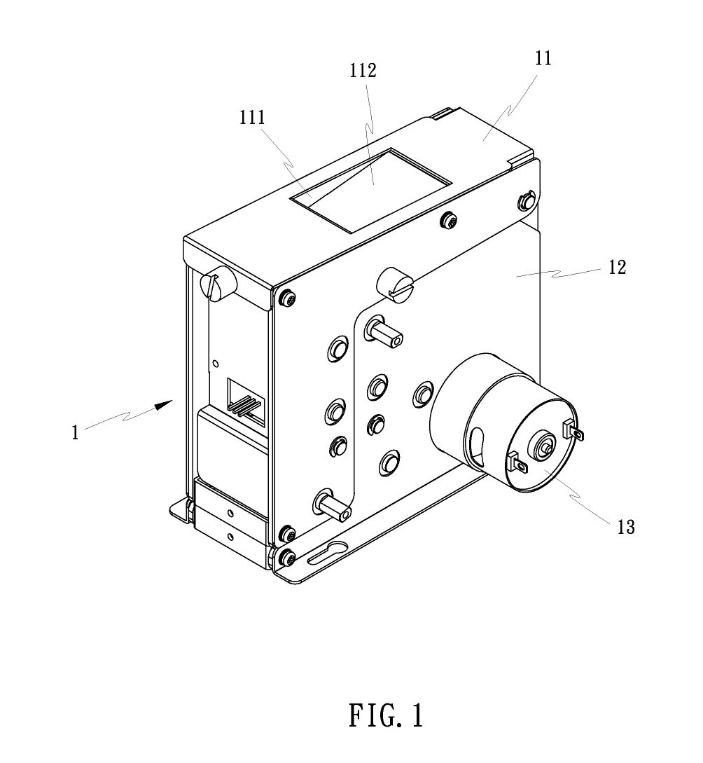

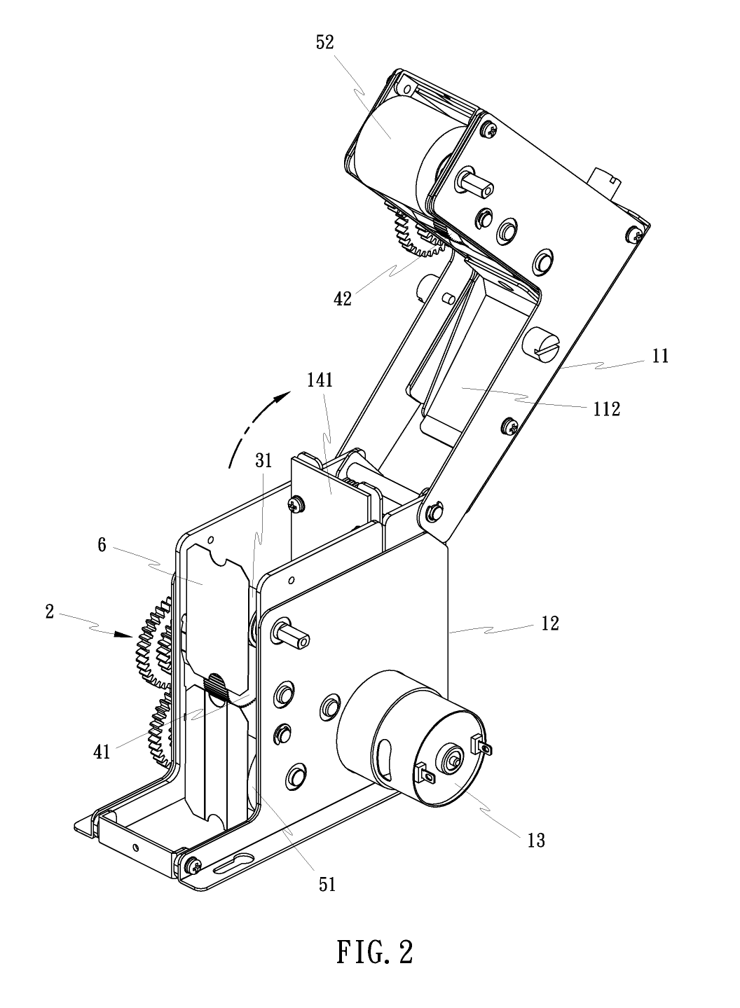

Referring to FIGS. 1-4, a lottery ticket destruction apparatus in accordance with the present invention is shown. The lottery ticket destruction apparatus comprises a housing 1, a transmission gear set 2, a set of sheet-transfer rollers 31;32, a set of rotary cutters 41;42, and a set of pull-and-push rollers 51;52.

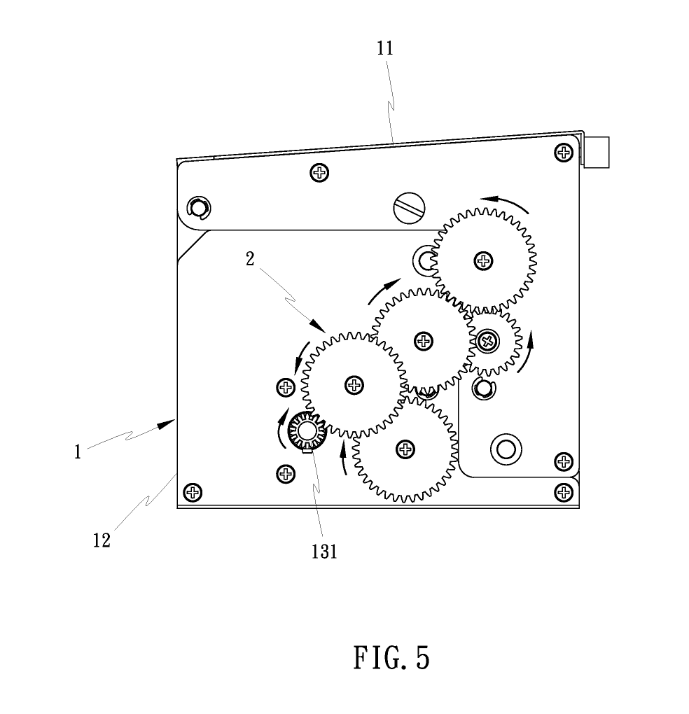

The housing 1 is a flip-turn design. As shown in FIG. 1, the housing 1 comprises a top cover shell 11 and a bottom body shell 12. The top cover shell 11 and the bottom body shell 12 are pivotally coupled together such that the top cover shell 11 can be turned relative to the bottom body shell 12 and opened. The top cover shell 11 comprises a top opening 111, and guide plates 112;113 for guiding lottery tickets inserted into the top opening 111 toward the inside of the bottom body shell 12. The bottom body shell 12 has mounted therein a motor 13 for driving a pinion 131 (see FIG. 5). Further, sensors 141;142 are respectively mounted in the top cover shell 11 and the bottom body shell 12.

The transmission gear set 2, as shown in FIG. 5, consists of a plurality of gears respectively mounted on the outer wall of the top cover shell 11 and the outer wall of the bottom body shell 12 and meshed with one another. Through a meshed transmission of different sizes of gears, the transmission gear set 2 can provide a driving effect of three different speeds.

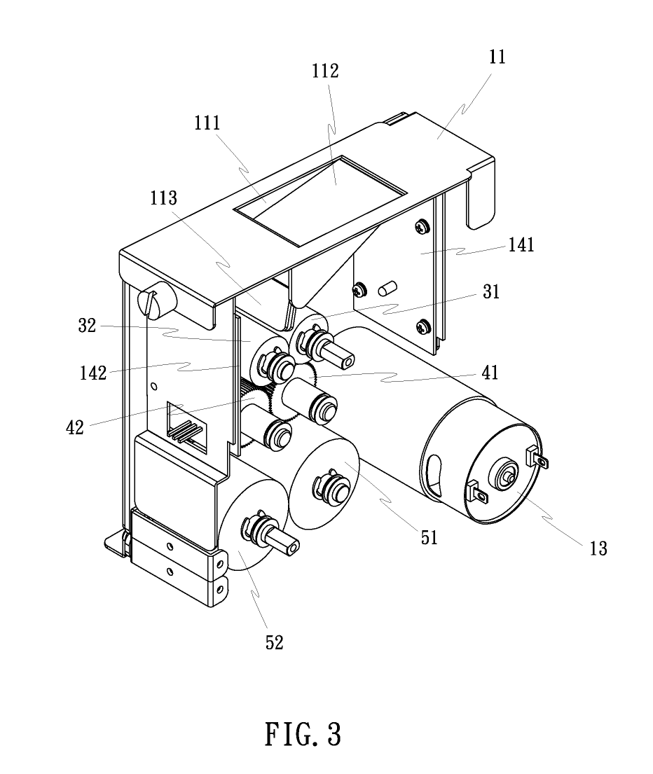

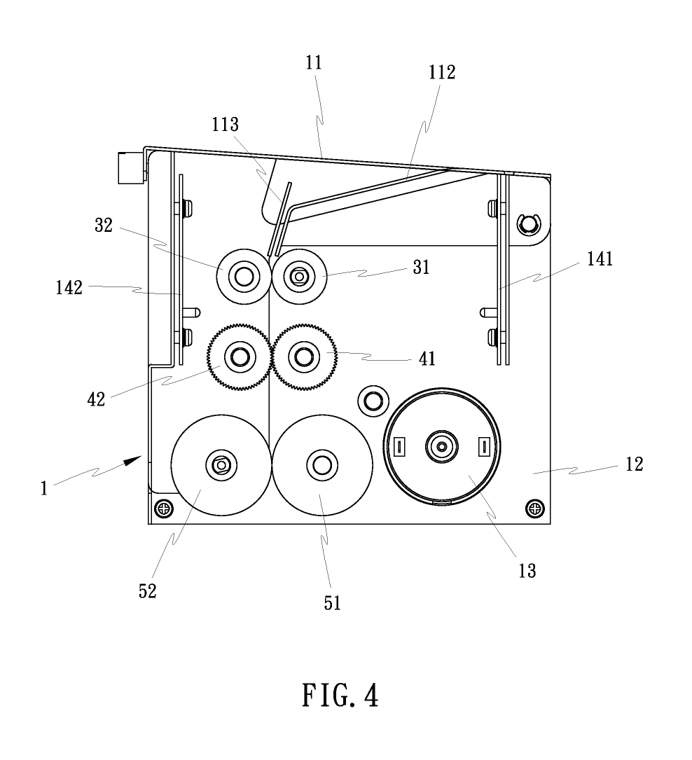

Referring to FIGS. 3 and 4, the sheet-transfer rollers 31;32 are arranged in pairs and disposed below the top opening 111 of the top cover shell 11. Further, the two sheet-transfer rollers 31;32 of one same pair are respectively pivotally mounted in the bottom body shell 12 and the top cover shell 11 to face each other, and rotatable by the transmission gear set 2 at a low speed.

The rotary cutters 41;42 are arranged in pairs below the set of sheet-transfer rollers 31;32. Further, the two rotary cutters 41;42 of one same pair are respectively pivotally mounted in the bottom body shell 12 and the top cover shell 11 to face each other, and rotatable by the transmission gear set 2 at a middle speed.

The pull-and-push rollers 51;52 are arranged in pairs below the set of rotary cutters 41;42. Further, the two pull-and-push rollers 51;52 of one same pair are respectively pivotally mounted in the bottom body shell 12 and the top cover shell 11 to face each other, and rotatable by the transmission gear set 2 at a high speed.

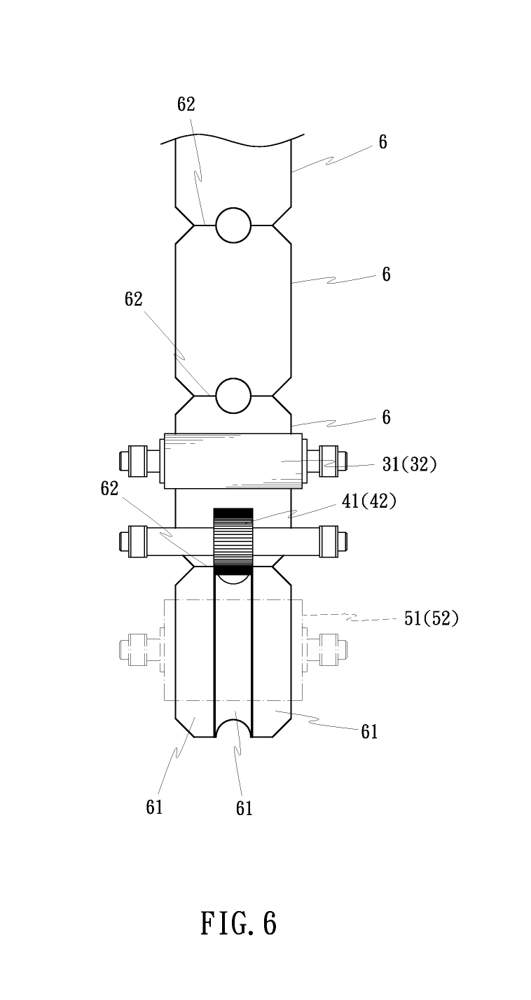

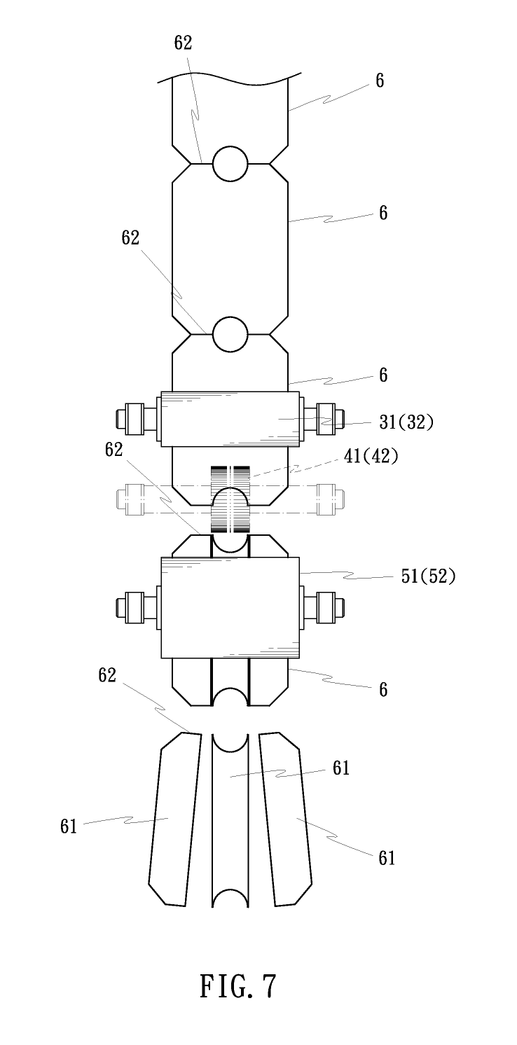

After the top cover shell 11 and the bottom body shell 12 are closed, a series of lottery tickets 6 can be inserted into the top opening 111 for destruction. Upon insertion of a series of lottery tickets 6 into the top opening 111, the sensors 141;142 sense the presence of the inserted series of lottery tickets 6 and then give a signal to start up the motor 13, driving the pinion 131 to rotate the set of sheet-transfer rollers 31;32 at a low speed, the set of rotary cutters 41;42 at a middle speed and the set of pull-and-push rollers 51;52 at a high speed. The inserted series of lottery tickets 6 are transferred in proper order through the set of sheet-transfer rollers 31;32 where the inserted series of lottery tickets 6 are flattened (see FIG. 6), the set of rotary cutters 41;42 where each lottery ticket 6 is cut into three narrow elongated strips, and the set of pull-and-push rollers 51;52 where the narrow elongated strips of the series of lottery tickets 6 is stretched and separated, one lottery ticket from another lottery ticket, into fragments 61 (see FIG. 7), thus saving waste lottery ticket storage space and facilitating a follow-up procedure.

Further, the flip-turn design of the housing 1 of the lottery ticket destruction apparatus enables a person to open the top cover shell 11 conveniently, facilitating inspection, maintenance or replacement of internal component parts. In case of a lottery ticket jam, the top cover shell 11 can be easily opened for troubleshooting without performing any complicated dismounting procedure.

Further, in this embodiment, the top cover shell 11 and bottom body shell 12 of the housing 1 are L-shaped shells matching each other for quick opening. However, this configuration design is not a limitation. Configuration modification is allowed without departing from the spirit and scope of the present invention.

Further, the set of sheet-transfer rollers 31;32 is rotated at a low speed. When a lottery ticket 6 is transferred through the set of sheet-transfer rollers 31;32, it is automatically flattened. Further, when a continuous series of lottery tickets 6 is transferred through the set of rotary cutters 41;42, the continuous series of lottery tickets 6 is cut into three narrow elongated pieces. These three narrow elongated pieces are then transferred through the set of pull-and-push rollers 51;52 that are rotated at a high speed. Due to the effect of speed difference between the set of rotary cutters 41;42 and the set of pull-and-push rollers 51;52, the three narrow elongated pieces of the continuous series of lottery tickets 6 are broken into fragments 61 along the boundary line 62 between each two adjacent lottery tickets of the continuous series of lottery tickets 6.

Although a particular embodiment of the invention has been described in detail for purposes of illustration, various modifications and enhancements may be made without departing from the spirit and scope of the invention. For example, the housing 1 can be an enclosed structure instead of the flip-turn design; other equivalent transmission mechanism can be selectively used to substitute for the transmission gear set 2, enabling the set of sheet-transfer rollers 31;32, the set of rotary cutters 41;42 and the set of pull-and-push rollers 51;52 to be rotated at low, middle and high speeds respectively. Accordingly, the invention is not to be limited except as by the appended claims.

What is claimed is:

1. A lottery ticket destruction apparatus, comprising:
a housing comprising a top opening for insertion of a series of lottery tickets and at least one guide plate for guiding the inserted series of lottery tickets in a predetermined direction;
a motor mounted in said housing and adapted for rotating a pinion;
sensor means mounted in said housing and adapted for sensing the presence of a lottery ticket in said top opening and starting said motor to rotate;
a transmission gear set mounted on the outside of said housing, said transmission gear set comprising a plurality of gears of different sizes meshed together to provide three different speeds;
at least one pair of sheet-transfer rollers mounted in said housing below said top opening and rotatable by said transmission gear set at a low speed to flatten each lottery ticket of the inserted series of lottery tickets;
at least one pair of rotary cutters mounted in said housing below said at least one pair of sheet-transfer rollers and rotatable by said transmission gear set at a middle speed to cut each lottery ticket flattened by said at least one pair of sheet-transfer rollers into three pieces; and
at least one pair of pull-and-push rollers mounted in said housing below said at least one pair of sheet-transfer rollers and rotatable by said transmission gear set at a high speed to stretch and separate the cut pieces of each lottery ticket from cut pieces of other lottery tickets of the series of lottery tickets.

2. The lottery ticket destruction apparatus as claimed in claim 1, wherein said housing comprises a bottom body shell, and a top cover shell pivotally coupled to said bottom body shell and flip-turnable relative to said bottom body shell.

3. The lottery ticket destruction apparatus as claimed in claim 2, wherein said top cover shell and said bottom body shell are L-shaped shells matching each other.

4. The lottery ticket destruction apparatus as claimed in claim 1, wherein said housing comprises a bottom body shell and a top cover shell; said sensor means comprises a plurality of sensors respectively mounted in said top cover shell and said bottom body shell.

5. The lottery ticket destruction apparatus as claimed in claim 1, wherein said housing comprises a bottom body shell and a top cover shell; said transmission gear set is mounted on said bottom body shell and said top cover shell at an outer side.

6. The lottery ticket destruction apparatus as claimed in claim 1, wherein said housing comprises a bottom body shell and a top cover shell; the two sheet-transfer rollers of each pair of said at least one pair of sheet-transfer rollers are respectively mounted in said bottom body shell and said top cover shell corresponding to each other.

7. The lottery ticket destruction apparatus as claimed in claim 1, wherein said housing comprises a bottom body shell and a top cover shell; the two rotary cutters of each pair of said at least one pair of rotary cutters are respectively mounted in said bottom body shell and said top cover shell corresponding to each other.

8. The lottery ticket destruction apparatus as claimed in claim 1, wherein said housing comprises a bottom body shell and a top cover shell; the two push-and-pull rollers of each pair of said at least one pair of push-and-pull rollers are respectively mounted in said bottom body shell and said top cover shell corresponding to each other.
